(19) United States
(12) Patent Application Publication
(10) Pub. No.: US 2023/0358071 A1
(43) Pub. Date: Nov. 9, 2023

(54) AN ANCHOR AND APPLICATOR FOR AGRICULTURAL FENCING

(71) Applicant: WIREMAN PTY LIMITED, New South Wales (AU)

(72) Inventor: Ian LOWREY, New South Wales (AU)

(21) Appl. No.: 18/245,733

(22) PCT Filed: Sep. 2, 2021
(86) PCT No.: PCT/AU2021/051019

§ 371 Date: Mar. 17, 2023

(30) Foreign Application Priority Data
Sep. 17, 2020 (AU) 2020903327
Nov. 18, 2020 (AU) 2020904262

(51) Int. Cl. E04H 17/08

(52) U.S. Cl. CPC E04H 17/08

(57) ABSTRACT

An anchor for a bottom wire (2) of an agricultural fence is disclosed. The anchor (1, 100) has a length of wire (3, 103, 203) and an arrowhead (10, 310). The length of wire has two ends (4, 5), a bend (6) and a generally U or V-shaped configuration. The arrowhead has a leading (21) and a trailing (22) end with the two ends being connectable to the arrowhead approximately midway between its leading and trailing ends. The arrowhead has a drive connector portion (23, 29) to permit the arrowhead to be connected to an applicator (12, 62, 112) and by means of which the arrowhead can be driven into ground (19) below the fence. The applicator has an elongate rod (13,113) having a tip (11) and a head (41) at opposite ends thereof, the head being shaped to transmit an inertial impulse to the rod. Methods are also disclosed.

### FIELD OF THE INVENTION

The present invention relates to agricultural fencing having a plurality of substantially horizontal wires and, in particular, to an anchor for a bottom one of the substantially horizontal wires.

### BACKGROUND ART

Agricultural fencing represents a substantial financial asset and considerable time and effort is expended during the erection of agricultural fencing. Although it is possible to dig a trench along the course of an agricultural fence and bury part of the fence in the trench, this relatively expensive step is not generally undertaken. As a consequence, the lowermost part of the fence (other than the fence posts themselves) lies immediately adjacent, and normally abutting, the soil over which the fence is built. There are many animals which attempt to burrow under the fence by passing between the soil and the bottom or lowermost wire of the fence. In Australia, often the site where animals initially burrow under the fence is selected by a small animal such as an echidna or a rabbit or a bigger animal such as a wombat. Once an initial path under the fence has been created, then larger animals such as kangaroos and feral pigs can smell this path and attempt to follow it themselves by forcing their way under the lowermost wire. This applies irrespective of whether the lowermost wire is a single wire, or is part of a wire mesh such as those sold under the names HINGELOCK and RINGLOCK. Such larger animals include feral pigs, kangaroos, foxes, deer, dingoes and wallabies. Paradoxically, kangaroos and wallabies which may be capable of jumping over a waist high fence normally prefer to burrow underneath it, if possible. Deer are also known to both jump over and burrow under fences.

In recent years exclusion fencing, formed from prefabricated mesh and often including a horizontally extending apron portion, has gained favour. However, there are many thousands of kilometres of existing conventional waist high fencing, mostly without any apron. Irrespective of whether or not a fence has an apron, it is still prone to being breached by burrowing animals. Often the passage of animals under a fence leads to the creation of an elongate depression which extends roughly at right angles to the fence. Such burrowing under is a particular problem where the fence does not travel along relatively uniform ground.

It is known for farmers to heap logs, branches, and other pieces of timber, and stones or rocks, into such elongate depressions in an attempt to prevent the passage of animals under the fence. Often the animals are strong enough to push the timber or stones to one side. It is also known to drive tent pegs into such elongate depressions with a view to holding down the lowermost wire of the fence. However, often the animals are sufficiently strong to lift the wire and thereby raise or even eject the tent peg. It is also known to drive one or more star pickets into such elongate depressions, however, whilst this is normally moderately successful, it is a relatively expensive way of preventing passage of animals under the fence.

Another, allied, fencing problem is to hold down the fence bottom wire where the fence crosses gullies, creek beds, and like.

### GENESIS OF THE INVENTION

The Genesis of the present invention is a desire to overcome, or at least ameliorate, the abovementioned problems.

### SUMMARY OF THE INVENTION

In accordance with a first aspect of the present invention there is disclosed an anchor for a bottom, substantially horizontal, wire of an agricultural fence having a plurality of substantially horizontal wires, said anchor comprising a length of wire and an arrowhead; said length of wire having two ends and a bend and having a generally U-shaped or V-shaped configuration with said ends being substantially equi-distant from said bend; and said arrowhead having a leading end and a trailing end, and said wire two ends being connectable to said arrowhead approximately midway between said leading and trailing ends thereof; and said arrowhead further having a drive connector portion to permit said arrowhead to be connected to an applicator by means of which said arrowhead can be driven into soil below said fence.

In accordance with a second aspect of the present invention there is disclosed a applicator for an anchor for a bottom, substantially horizontal, wire of an agricultural fence having a plurality of substantially horizontal wires, said applicator comprising an elongate rod having a tip and a head at opposite ends thereof, said tip being engageable with a drive connector portion of an arrowhead of said anchor, and said head being shaped to transmit an inertial impulse to said rod.

According to another aspect of the present invention there is provided a method of driving an anchor as defined above into soil below a fence using the applicator as defined above, said method comprising the steps of:
if necessary, connecting the ends said length of wire of U-shaped configuration to said arrowhead;
inter-engaging said tip of said applicator with said drive connector portion of said arrowhead;
applying inertial impulses to said applicator head to drive said tip into said soil; and
withdrawing said applicator rod from said soil whilst leaving said arrowhead buried in said soil to thereby position a portion of said wire adjacent said bottom wire.

In accordance with a still further aspect of the present invention there is disclosed a connector wire for use with the anchor as defined above, said connector wire comprising a substantially U-shaped or V-shaped bend, and a pair of ends substantially equidistant from said bend and being shaped to engage with said arrowhead.

Preferably, the bend is covered by plastic during manufacture of said anchor, and/or the wire two ends each have a substantially kinked or L-shaped configuration, and/or the arrowhead has a pair of holes each of which is dimensioned to engage a corresponding one of the wire two ends and/or the arrowhead is substantially planar and/or the arrowhead is bent to form a concave surface and a convex surface and/or the wire is selected from the class consisting of high tensile steel fencing wire, low tensile steel fencing wire, stainless steel wire, plastic coated wire, galvanised wire, tie wire and braided cable.

Preferably, the drive connector portion comprises both a substantially U-shaped recess in arrowhead trailing end and a central orifice in the arrowhead.

Preferably, the applicator tip has a longitudinally aligned slot therein engageable with the drive connector portion and/or the head includes a reciprocally mounted inertial mass and/or the head is engageable with an applicator driver having an inertial mass.

Preferably, the length of wire of U-shaped or V-shaped configuration is passed around the bottom wire and/or the wire is partially drawn out of said soil to thereby firmly inter-engage the soil and the arrowhead and/or the wire adjacent the bend is twisted or wound to engage the wire of U-shaped or V-shaped configuration with the bottom wire.

Preferably, the said arrowhead is bent to simultaneously form opposite convex and concave surfaces on the arrowhead, and the arrowhead driven into the soil with the concave surface lower than the convex surface.

Preferably, the connector wire has each end substantially kinked and/or the bend and the wire adjacent the bend are coated with a plastics material and/or the wire is selected from the class consisting of high tensile steel fencing wire, low tensile steel fencing wire, stainless steel wire, plastic coated wire, galvanised wire, tie wire and braided cable.

### BRIEF DESCRIPTION OF THE DRAWINGS

Several embodiments of the present invention will now be described, by way of example only, with reference to the accompanying drawings in which:

FIG. 1 is a schematic perspective view of the anchor of a first embodiment in the process of being driven into the ground below a lowermost fence wire,

FIG. 2 is a similar schematic perspective view showing the arrowhead fully inserted and the applicator being decoupled from the arrowhead,

FIG. 3 is a similar schematic perspective view showing the installed anchor,

FIG. 4 is a plan view of the arrowhead of the preferred embodiment,

FIG. 5 is a plan view of a strip of sheet steel from which the arrowheads can be fabricated in a scrap free manner,

FIG. 6 is a perspective view of the tip of the applicator,

FIG. 7 is a perspective view from one side of the applicator showing the arrowhead installed on the applicator tip,

FIG. 8 is a perspective view from the other side of the applicator showing the arrowhead installed on the applicator tip,

FIG. 9 is a perspective view from one side showing the arrowhead partially disengaged from the applicator tip,

FIG. 10 is a perspective view from the opposite side showing the arrowhead partially disengaged from the applicator tip,

FIGS. 11-14 are a sequence of perspective views showing the stages of the arrowhead disengaging from the applicator tip as a consequence of withdrawal of the applicator (the length of wire being omitted so as to not overburdened the drawings),

FIG. 15 is a truncated perspective view of a first embodiment of the length of wire prior to its connection to the arrowhead,

FIG. 16 is a perspective view of the arrowhead showing the first stage of connection of the wire thereto,

FIG. 17 is a perspective view of the arrowhead showing the second stage of connection of the wire thereto,

FIG. 18 is a perspective view from above showing the applicator tip engaged with the arrowhead and the wire engaged with the arrowhead,

FIG. 19 is a perspective view from below showing the wire engaged with the arrowhead and the arrowhead disengaged from the applicator tip following initial retraction of the applicator,

FIGS. 20-22 are perspective views from one side showing successive stages of the insertion of the arrowhead,

FIG. 23 is a perspective view of a first embodiment of an applicator,

FIG. 24 is a perspective view of a second embodiment of an applicator,

FIG. 25 is an exploded perspective view of a third embodiment of an applicator,

FIG. 26 is an enlarged view of part of FIG. 25,

FIG. 27 is a perspective view of the underside of a driver,

FIG. 28 is a perspective view showing the applicator of FIGS. 25-27 driving upwardly,

FIG. 29 is a perspective view similar to FIG. 28 but showing the applicator driving downwardly,

FIG. 30 is a schematic perspective view of an anchor of a second embodiment,

FIG. 31 is an enlarged perspective view of the arrowhead of the anchor of FIG. 30,

FIG. 32 is a perspective view from above of an arrowhead of a further embodiment,

FIG. 33 is another perspective view of the arrowhead of FIG. 32,

FIGS. 34-36 reproduce FIGS. 1-3 but illustrating the arrowhead of FIGS. 32-33

FIGS. 37-39 reproduce FIGS. 17-19 but illustrating the arrowhead of FIGS. 32-33,

FIGS. 40-42 reproduce FIGS. 20-22 but illustrating the arrowhead of FIGS. 32-33,

FIG. 43 is a perspective view of an applicator rod including a squat cylinder,

FIG. 44 is a perspective view of the squat cylinder including two key ways,

FIG. 45 is a truncated perspective view of a second embodiment of the length of wire, and

FIG. 46 is a truncated perspective view of a third embodiment of the length of wire.

### DETAILED DESCRIPTION

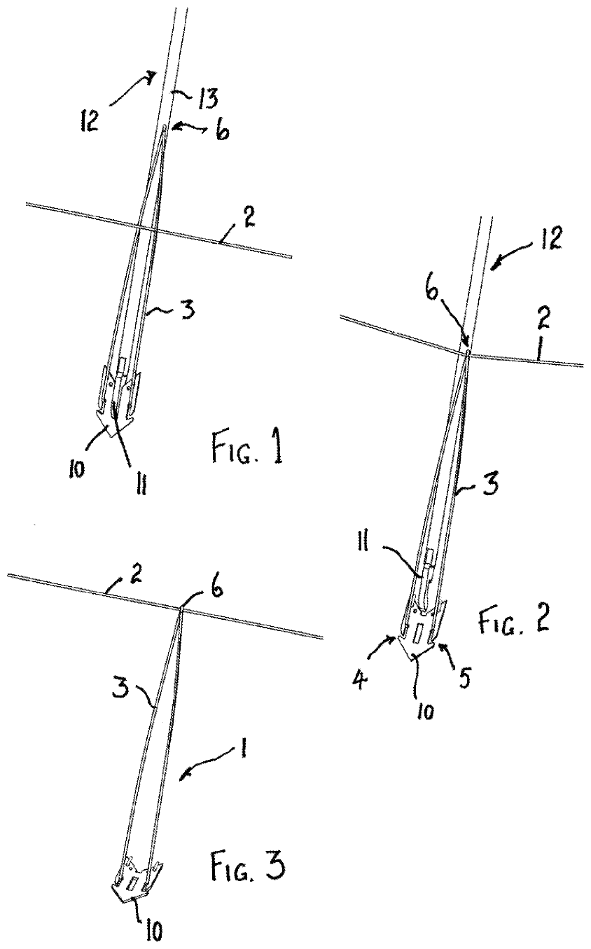

As seen in FIGS. 1-3, an anchor 1 for a bottom substantially horizontal wire 2 of an agricultural fence (not illustrated) having a plurality of substantially horizontal wires, is illustrated. The anchor 1 takes the form of a length of wire 3 having two ends 4, 5 and a generally U-shaped configuration with a bend 6 at its upper end. The two ends 4, 5 are preferably substantially equidistant from the bend 6 and are engaged with an arrowhead 10. The arrowhead 10 is itself engaged with a tip 11 of an applicator 12 having a rod 13. Only the lower end of the applicator 12 is illustrated in FIGS. 1 and 2.

As illustrated in FIG. 1, the arrowhead 10 is able to be driven into the ground 19 (not illustrated in FIG. 1) so that the bend 6 approaches the bottom wire 2. At the conclusion of this process, the bend 6 has engaged the bottom wire 2 and depressed same downwardly somewhat into the ground as seen in FIG. 2. With the bend 6 fully engaged with the bottom wire 2, the applicator 12 is withdrawn so as to disengage the tip 11 from the arrowhead 10. The initiation of this process is illustrated in FIG. 2.

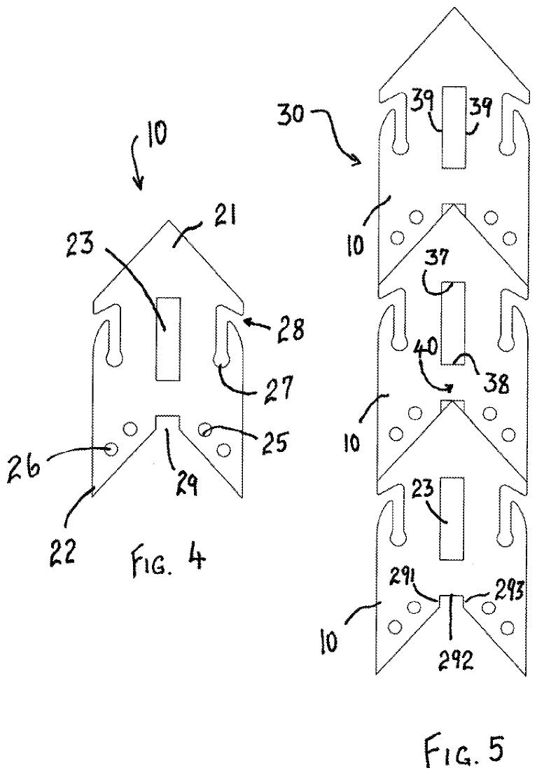

Finally, as illustrated in FIG. 3, the applicator 12 is completely withdrawn leaving the anchor 1 in its final position with the arrowhead 10 buried in the ground and the bend 6 engaged with the bottom wire 2. If then an animal should attempt to raise the bottom wire 2, this upward movement of the bottom wire 2 is resisted by the reluctance of the arrowhead 10 be pulled upwardly through the ground. That is to say, the arrowhead 10 and length of wire 3 prevent the bottom wire 2 from being raised.

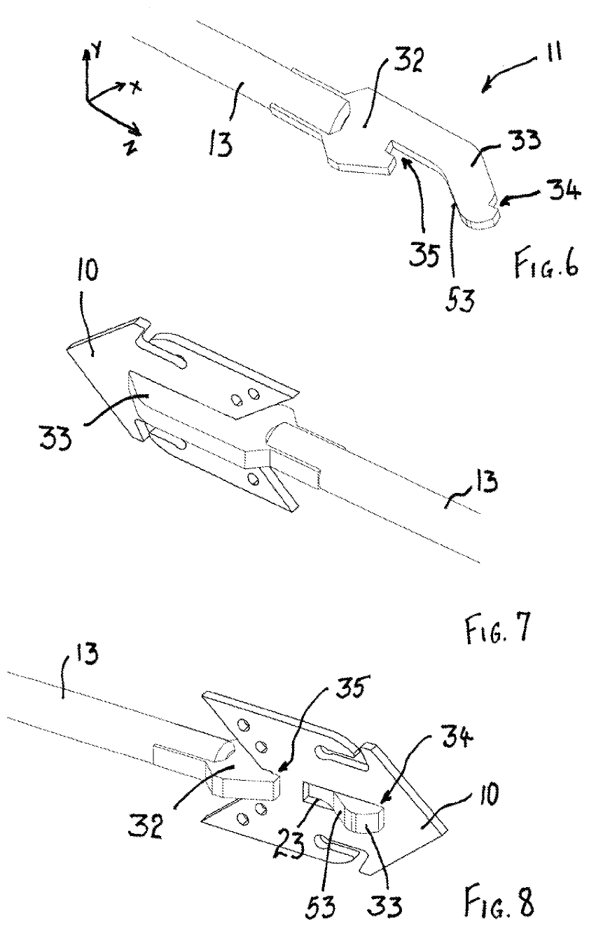

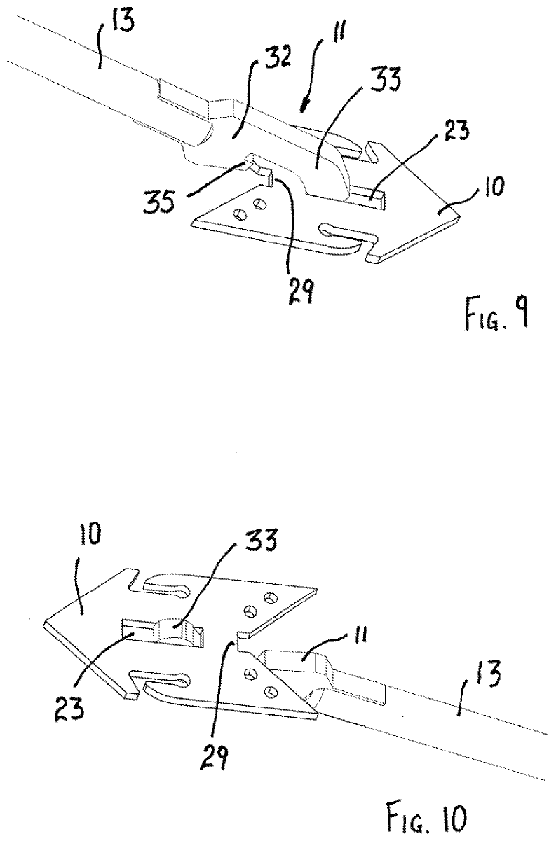

The arrowhead 10 is illustrated in more detail in FIGS. 4 and 5. The arrowhead 10 is preferably cut or stamped from galvanised steel plate which is preferably 3 mm thick. The arrowhead 10 has a tip 21, a tail 22, and a rectangular central orifice 23. The tail 22 is provided with a pair of inner holes 25 and a pair of outer holes 26. Approximately midway between the tip 21 and tail 22 is a pair of middle holes 27 each of which has a passageway 28 leading thereto. Aligned with the orifice 23 is a recess 29.

The orifice 23 has a leading edge 37 and a trailing edge 38 and side walls 39 which extend between these edges. A bridge 40 extends between the orifice 23 and the recess 29. The recess 29 has three edges 291, 292 and 293 as illustrated in FIG. 5. Both the orifice 23 and recess 29 are utilised in the inter-engagement between the arrowhead 10 and the tip 11 of the applicator 12.

It will be seen from FIG. 5 that the arrowheads 10 can be stamped or cut from a strip 30 of galvanised steel in a manner which leaves substantially no waste.

Turning now to FIG. 6, the tip 11 of the applicator 12 is illustrated. The tip 11 is cut from sheet steel and welded to the lower end of the rod 13 of the applicator 12. The tip 11 is shaped so as to form a palm 32 and a finger 33. The finger 33 has a notch 34 which mates with the orifice 23 of the arrowhead 10. The notch 34 has three flat surfaces. The finger 33 also has a setting angle surface 53. The palm 32 has a slot 35 which mates with the recess 29 of the arrowhead 10. The slot 35 has four flat surfaces.

In FIG. 6, X, Y and Z axes are marked for reference regarding the direction of movement of the applicator tip 11 and the arrowhead 10.

The arrowhead 10 is assembled and inter-engaged with the tip 11 as illustrated in FIGS. 7-10. As best seen in FIGS. 9 and 10, in order to assemble the arrowhead 10 and tip 11, the finger 33 is first passed into the orifice 23 and then slid forwardly in the direction of the Z axis so as to simultaneously engage the notch 34 (FIG. 8) and the leading edge 37 of the orifice 23 and also engage the slot 35 and recess 29.

In this position, in relation to the Z axis, the arrowhead 10 cannot move to the rear towards the rod 13 because the trailing edge 38 of the orifice 23 is engaged with the third surface of the notch 34, and also because the edge 292 of the recess 29 abuts the third surface of the slot 35. However, there is nothing preventing the arrowhead 10 moving forwardly in relation to the Z axis.

In relation to the X axis, the bridge 40 of the arrowhead 10 is firmly held between the second and fourth surfaces of the slot 35. Also the leading edge 37 abuts the second surface of the notch 34. So the arrowhead 10 cannot move in either direction with respect to the X axis.

Similarly, in relation to the Y axis, the edges 291, 293 of the recess 29 are engaged with either side of the palm 32. Also, the sidewalls of the orifice 23 abut the finger 33. So the arrowhead 10 cannot move in either direction with respect to the Y axis.

Conversely, in order to dis-assemble the arrowhead 10 and tip 11, the applicator 12 is moved rearwardly relative to the arrowhead 10 along the Z axis, thereby simultaneously disengaging both the notch 34 and the slot 35 from their respective engagements with the arrowhead 10. The finger 33 is shaped so that the setting angle surface 53 (FIG. 8) strikes the trailing edge 38 of the orifice 32 so as to initiate and facilitate the tilting of the tail 22 of the arrowhead 10 away from the rod 13. This tilting action is continued as the trailing edge 38 of the orifice 23 passes over the extremity of the finger 33.

This tilting disengagement is illustrated in FIGS. 11-14 from which it will be seen that as the rod 13 moves away from the anchor 10 (bearing in mind that the latter is surrounded by earth or ground) so the anchor 10 is progressively moved so as to be inclined to, and preferably almost perpendicular to, the path of insertion of the arrowhead 10 into the ground.

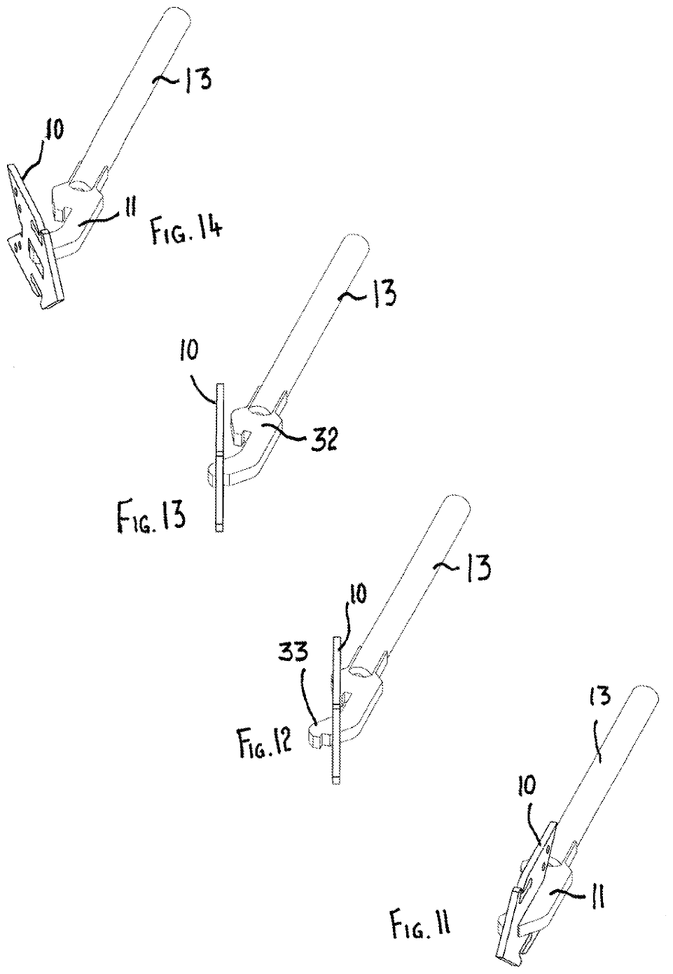

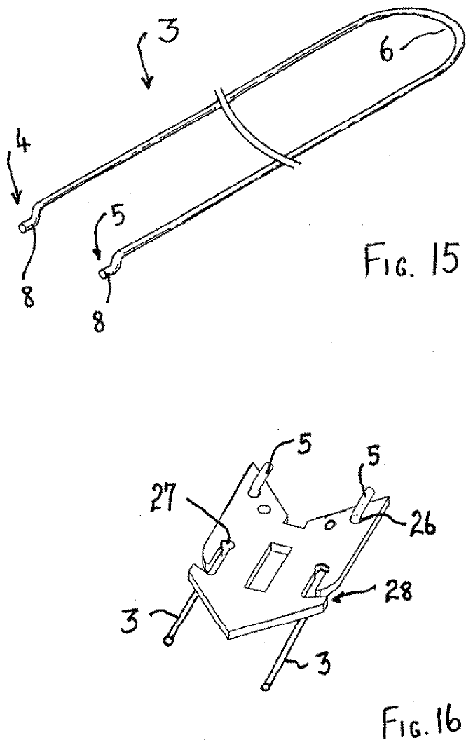

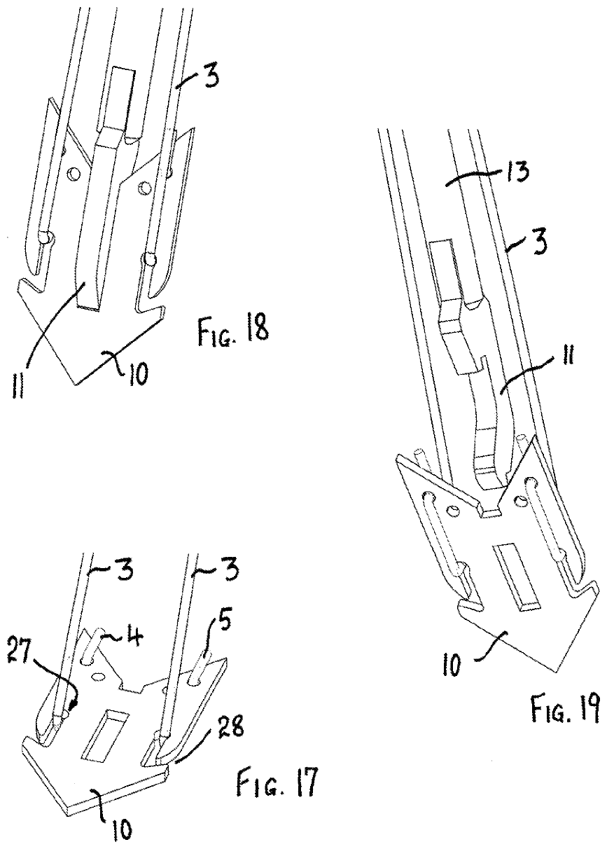

The inter-engagement of the length of wire 3 with the arrowhead 10 will now be described with reference to FIGS. 15-19. In FIG. 15 it will be seen that the wire 3 has its ends 4, 5 substantially equidistant from the bend 6. In addition, each of the ends 4, 5 is preferably provided with a kink 8. As seen in FIG. 16, with the arrowhead 10 pointing towards the bend 6, the kinked ends 4, 5 are inserted into a respective one of the outer holes 26. In this configuration as seen in FIG. 16, the arrowhead 10 can be held with one hand and the other hand used to lead one side of the wire 3 into the passageway 28 and into engagement with the corresponding middle hole 27. This process is repeated for the other side of the wire 3. Thereafter, these portions of the wire 3 can be bent towards its corresponding end 4 or 5 as illustrated in FIG. 17. When this is done the arrowhead 10 no longer points towards the bend 6 but instead points away from the bend 6 as illustrated in FIGS. 18 and 19.

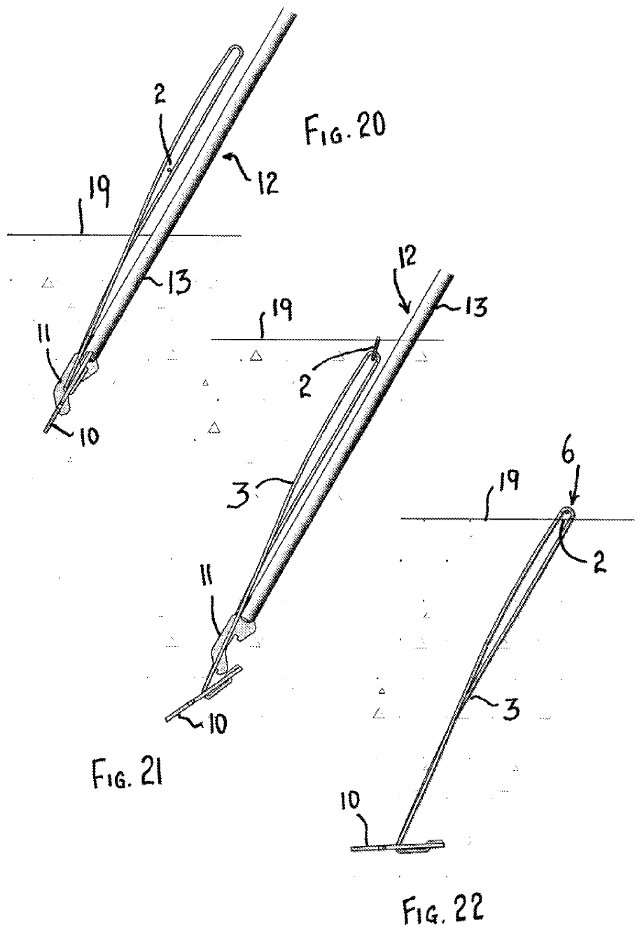

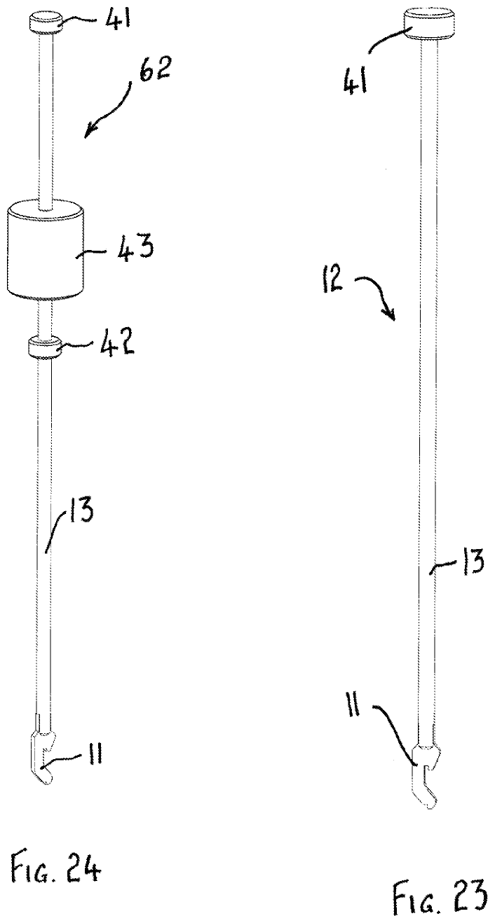

In the light of the foregoing, it will be appreciated from FIGS. 20-22 (which to some extent duplicate FIGS. 1-3) that the length of wire 3 can be passed around the bottom wire 2 of the fence and then engaged with the arrowhead 10. The arrowhead 10 is then engaged with the tip 11, and the applicator 12 is driven downwardly into the ground 19 so as to insert the anchor 10 to the maximum depth possible, normally determined by the length of the wire 3. In this condition, the bottom fence wire 2 is depressed below the level of the ground 19 as illustrated in FIG. 21. Thereafter the rod 13 of the applicator 12 is withdrawn from the ground so as to disengage the tip 11 from the arrowhead 10. An upwardly directed force is applied to the wire 3 by the bottom wire 2 which therefore tends to tilt the arrowhead 10 so that it preferably lies generally parallel with the surface of the ground 19 and roughly perpendicular to the wire 3.

Thus the two engagement points of the wire 3 with the middle holes 27 of the arrowhead 10 constitute fulcrum points or pivot points about which the arrowhead 10 is able to rotate. If desired, the wire 3 can preferably be partially drawn out of the soil to thereby more firmly inter-engage the soil and the arrowhead, and the bend 6 wrapped around the wire 2.

FIG. 23 illustrates the applicator 12 of a first embodiment in which the upper end of the rod 13 terminates in a disc 41 which is welded to the upper end of the rod 13. This forms a mass with which a sledgehammer or other tool (neither illustrated) can be used to engage with the applicator 12 and repeatedly apply downwardly directed inertial forces to the applicator 12, thereby permitting the tip 11 of the rod 13 to be driven or hammered into the ground 19.

In a second embodiment illustrated in FIG. 24, again the upper end of the rod 13 terminates in a disc 41 which is welded to the upper end of the rod 13. In addition, the applicator 62 has a second disc 42 which is welded to the middle of the rod 13. Slidingly mounted on the rod 13 between the discs 41, 42 is a slap hammer 43 which can be manually reciprocated to either repeatedly strike the upper surface of the disc 42 (and thereby drive the tip 11 downwardly) or repeatedly strike the lower surface of the disc 41 (and thereby drive the rod 13 upwardly).

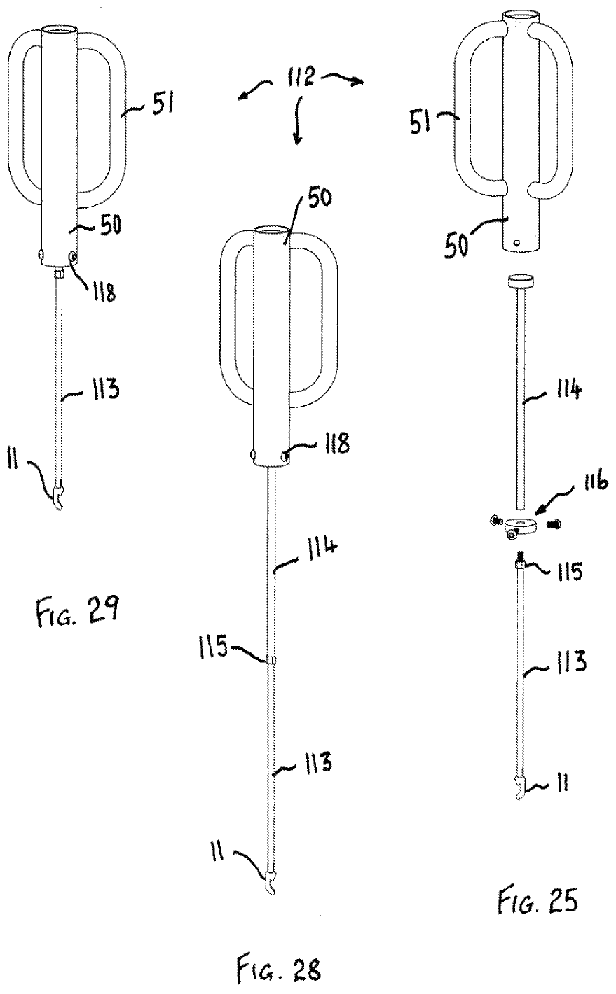

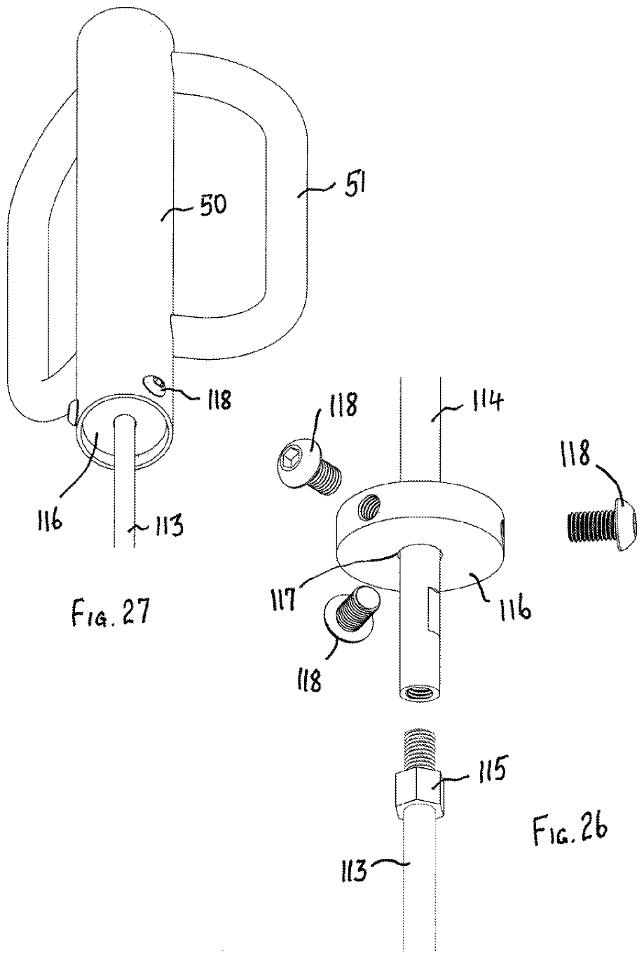

In a third embodiment as illustrated in FIGS. 25-29, an applicator 112 is constructed from three major pieces. A lower rod 113 is provided with the tip 11 and has an upper end with a male thread and a nut 115. An upper rod 114 is provided at its upper end with the disc 41 and at its lower end with a female thread which mates with the male thread of the lower rod 113. There is a squat cylinder 116 which is dimensioned so that its interior hole 117 slides on the upper rod 114. Three fasteners 118 permit the squat cylinder 116 to be secured to the lower end of a substantially conventional fence post driver 50 having two handles 51. As will be explained hereafter, the squat cylinder 116 converts a substantially conventional post driver into a slap hammer style of tool.

In order to drive the tip 11 into the ground, the driver 50 is used as illustrated in FIG. 29 so that the upper end of the driver repeatedly impacts on the upper surface of the disc 41 of the upper rod 114. Thus, repeated impacts between the top of driver 50 and the upper surface of the disc 41 drive or hammer the tip 11 into the ground. Conversely, when it is desired to remove the tip 11 from the ground, the driver 50 is used as illustrated in FIG. 28 so that the upper surface of the squat cylinder 116 repeatedly impacts the lower surface of the disc 41. In this way the same driver 50 is able to perform two functions.

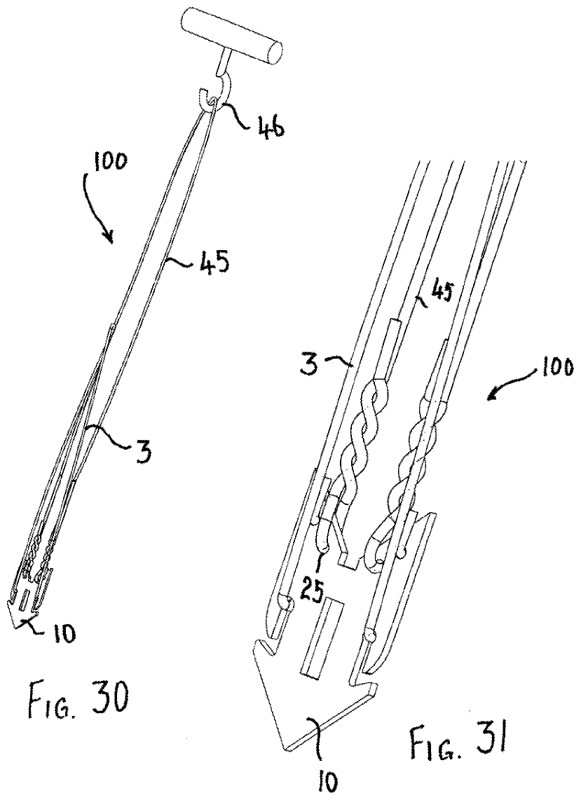

Turning now to FIGS. 30 and 31, an anchor 100 of a second embodiment is illustrated which is substantially the same as the anchor 1. A retractable lanyard 45 is connected in U-shaped configuration to the inner holes 25 in the arrowhead 10. Thus the anchor 100 can be used in relation to tents in a camping situation, for example, where it is intended that the anchor 100 be able to be withdrawn from the ground at the conclusion of the camp. This is possible by use of the retracting hook 46 which is able to engage the upper end of the lanyard 45 and thereby enable the arrowhead 10 of the anchor 100 to be pulled upwardly and thereby withdrawn from the ground.

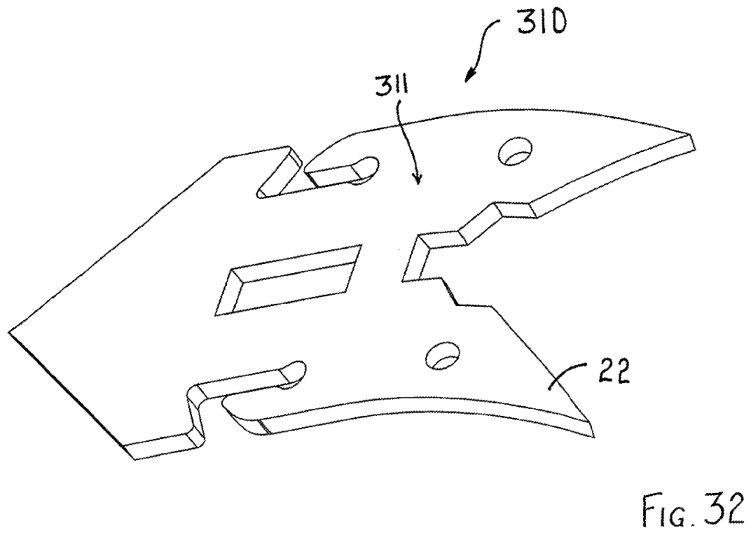

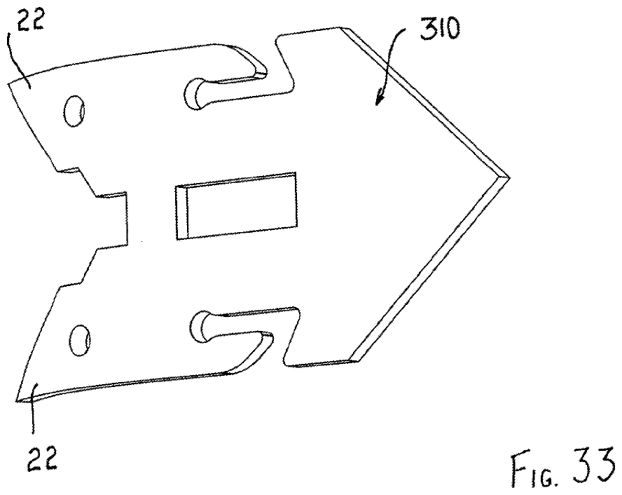

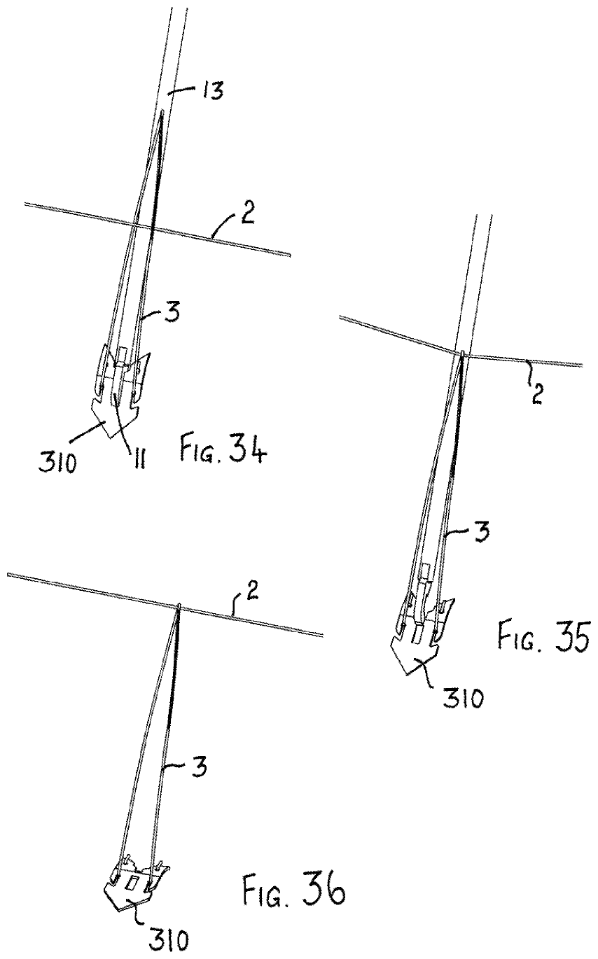

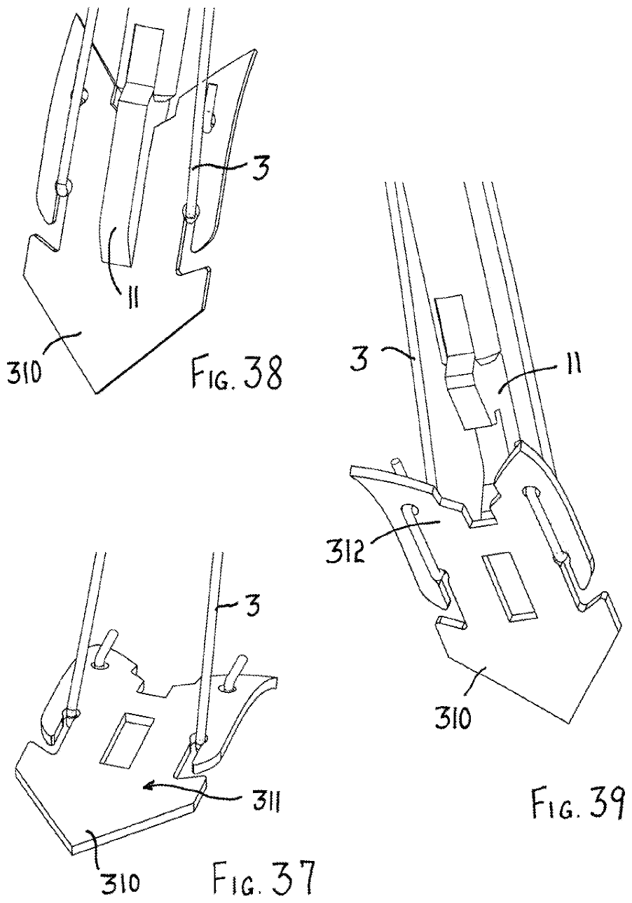

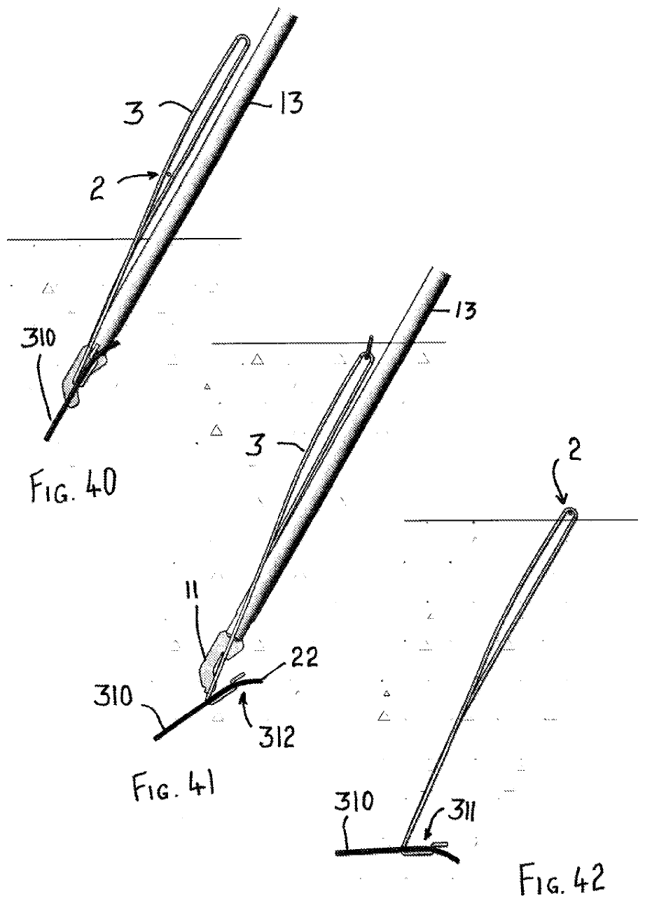

Turning now to FIGS. 32-33, a further embodiment of an arrowhead 310 is illustrated, the arrowhead 310 being slightly bent or curved so that one face 311 is substantially convex and the other face 312 is substantially concave. As before a length of wire 3 is provided which can be high tensile fencing wire, low tensile fencing wire, plastic coated wire, stainless steel wire, galvanised wire, tie wire or a braided cable. As seen in FIGS. 34-36, the interconnection of the arrowhead 310 and the tip 11 of the applicator 12 is as before. However, as best seen in FIGS. 37-38, the curved nature of the arrowhead 31 with its concave face 312 downwardly, assists the arrowhead 310 in turning or rotating after disengagement of the tip 11. In particular, the tails 22 of the arrowhead 310, as the wire 3 is pulled upwardly following disengagement the tip 11, form two curved, sharp, and forwardly moving tips or points which better engage with the ground 19 and turn the arrowhead 310 into the desired orientation. This is illustrated in the sequence of actions represented in FIGS. 40-42.

Turning now to FIGS. 43 and 44, the squat cylinder 116 of the fence post driver 50 can have its interior hole 117 provided with two oppositely aligned keyways 120. The keyways 120 are as wide as the tip 11 is thick. As a consequence, the squat cylinder 116 can be slid onto a rod 13 of the type illustrated in FIGS. 23 and 43, thereby enabling the fence post driver 50 to be secured to such a rod 13. That is, a fence post driver 50 can be provided with a one piece rod 13.

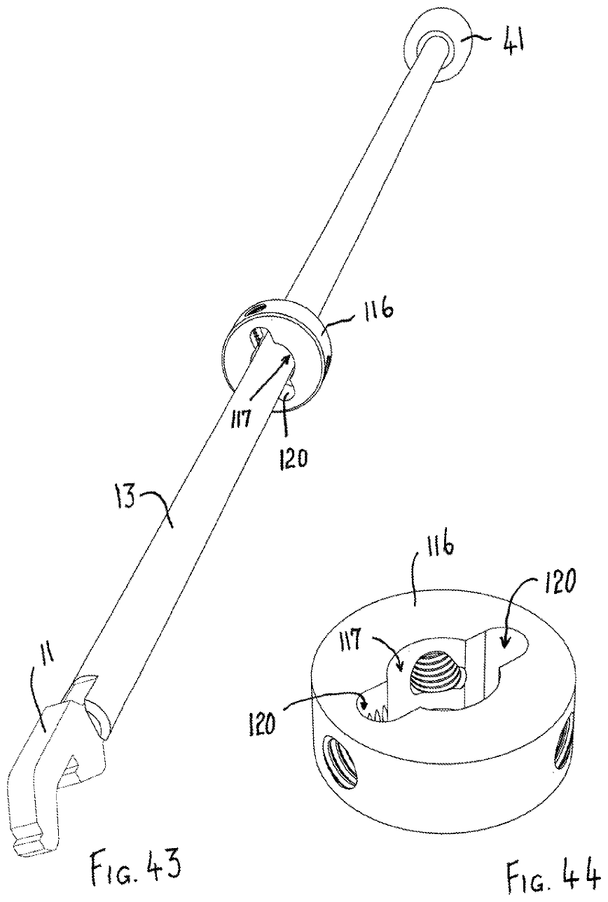

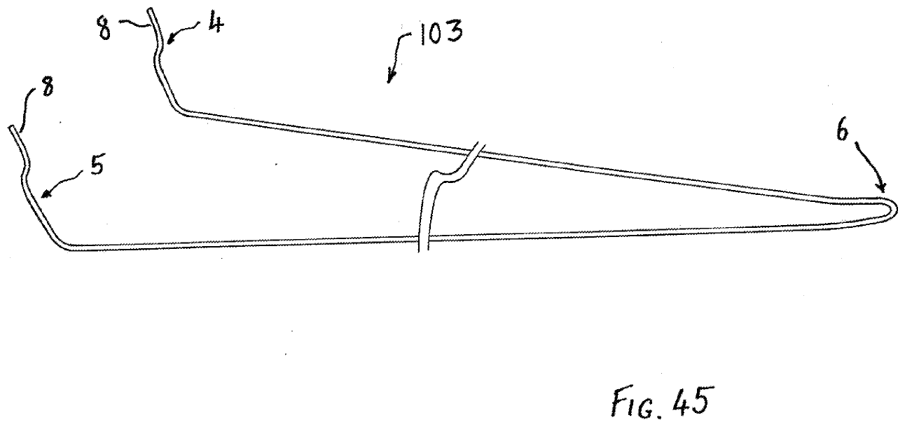

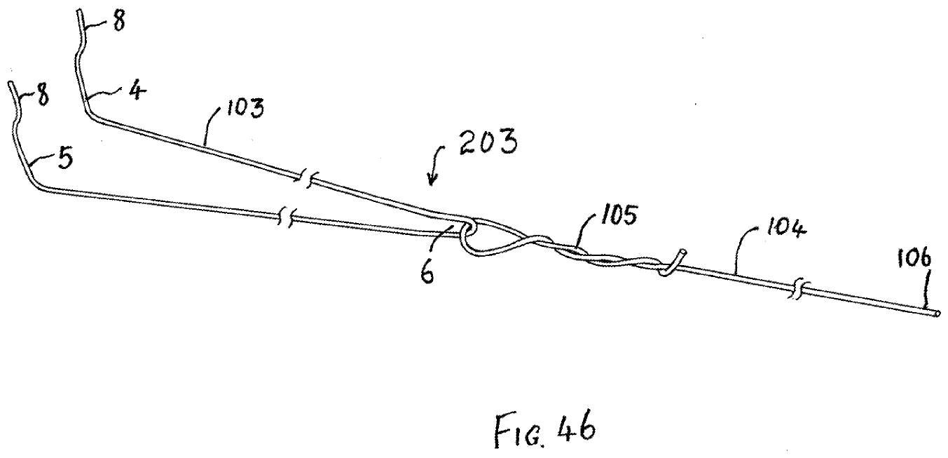

As seen in FIG. 45, the length of wire 3 can be modified so that the bend 6 is more somewhat sharper thereby giving rise to a length of wire 103 of substantially V-shaped configuration as illustrated in FIG. 45 as compared to a substantially U-shaped configuration as illustrated in FIG. 15. In addition, as seen in FIG. 46, in a third embodiment the length of wire 203 is manufactured in two pieces, one of which is substantially the wire 103 of FIG. 45 to which is added a second length 104 having one end formed into a twist 105 about the bend 6 and the other in 106 being free and able to be wound about the fence wires such as the bottom wire 2.

The foregoing describes only some embodiments of the present invention and modifications, obvious to those skilled in the rural fencing arts, can be made thereto without departing from the scope of the present invention. For example, if the depth of soil able to be penetrated by the arrowhead 10, 310 below the ground level 19 should be less than the length of the wire 3, because of rocks or other obstructions, then under these conditions the bend 6 will not be engaged with the bottom wire 2 as desired. Clearly this can be rectified by use of a shorter length of wire 3. However, the situation can also be rectified by placing an object such as the shaft of a screwdriver, or the hook 46, through the bend 6 and turning the length of wire 3 about its longitudinal axis. This has the result that the wire 3 is twisted and shortened, thereby drawing the bend 6 downwardly so as to engage the twisted wire adjacent the bend 6 with the bottom wire 2. This then prevents the bottom wire 2 being raised by an animal attempting to get underneath the fence. Alternatively, that portion of the wire 3 above ground level 19 can be twisted around the bottom wire 2 in the manner of a helix or coil so as to engage the bottom wire 2 with the anchor 1, 100.

Furthermore, if desired, the bend 6 and the adjacent portions of the wire 3, 103 can be dipped in molten plastic or passed through a bed of agitated plastic particles during manufacture of the anchor 1. This provides a protective coating against corrosion (in addition to any galvanising of the wire 3) and also makes the wire less likely to be manipulated in a way which causes the wire to snap. Alternatively, the wires 3, 103, 104 can be fabricated from annealed stainless steel wire.

The term “comprising” (and its grammatical variations) as used herein is used in the inclusive sense of “including” or “having” and not in the exclusive sense of “consisting only of”.

1. An anchor for a bottom, substantially horizontal, wire of an agricultural fence having a plurality of substantially horizontal wires, said anchor comprising a length of wire and an arrowhead; said length of wire having two ends and a bend and having a generally U-shaped or V-shaped configuration with said ends being substantially equi-distant from said bend; and said arrowhead having a leading end and a trailing end, and said wire two ends being connectable to said arrowhead approximately midway between said leading and trailing ends thereof; and said arrowhead further having a drive connector portion to permit said arrowhead to be connected to an applicator by means of which said arrowhead can be driven into soil below said fence, and wherein said drive connector portion has a rearwardly opening recess at said trailing end and a longitudinally extending orifice located between said trailing and leading ends, said orifice and said recess being shaped to engage with a finger and a slot respectively of said applicator, said finger being shaped to engage with, and extend through, said orifice from one side of said arrowhead to the other, and said slot being spaced from said finger and sized to engage both sides of said arrowhead in the vicinity of said rearwardly opening recess.

2. The anchor as claimed in claim 1 wherein said bend is covered by plastic during manufacture of said anchor.

3. The anchor as claimed in claim 1 wherein said wire two ends each have a substantially kinked or L-shaped configuration.

4. The anchor as claimed in claim 3 wherein said arrowhead has a pair of holes each of which is dimensioned to engage a corresponding one of said wire two ends.

5. The anchor as claimed in claim 1 were in said arrowhead is substantially planar.

6. The anchor as claimed in claim 5 wherein said arrowhead is bent to form a concave surface and a convex surface.

7. The anchor as claimed in claim 1 wherein said wire is selected from the group consisting of high tensile steel fencing wire, low tensile steel fencing wire, stainless steel wire, plastic coated wire, galvanised wire, tie wire and braided cable.

8. The anchor as claimed in claim 1 wherein said recess in said arrowhead trailing end is substantially U shaped.

9. An applicator for an anchor for a bottom, substantially horizontal, wire of an agricultural fence having a plurality of substantially horizontal wires, said applicator comprising an elongate rod having a tip and a head at opposite ends thereof, said tip being engageable with a drive connector portion of an arrowhead of said anchor, said head being shaped to transmit an inertial impulse to said rod, and said applicator having a finger and a slot, said finger being shaped to engage with, and extend through, said arrowhead orifice from one side of said arrowhead to the other, and said slot being spaced from said finger and sized to engage both sides of said arrowhead in the vicinity of said rearwardly opening recess.

10. The applicator as defined in paragraph 9 wherein said slot is longitudinally aligned with said drive connector portion.

11. The applicator as claimed in claim 9 wherein said head includes a reciprocally mounted inertial mass.

12. The applicator as defined in claim 9 wherein said head is engageable with an applicator driver having an inertial mass.

13. A method of driving an anchor for a bottom, substantially horizontal, wire of an agricultural fence having a plurality of substantially horizontal wires into soil below a fence using the applicator as claim 9, wherein said anchor comprising a length of wire and an arrowhead; said length of wire having two ends and a bend and having a generally U-shaped or V-shaped configuration with said ends being substantially equi-distant from said bend; and said arrowhead having a leading end and a trailing end, and said wire two ends being connectable to said arrowhead approximately midway between said leading and trailing ends thereof; and said arrowhead further having a drive connector portion to permit said arrowhead to be connected to an applicator by means of which said arrowhead can be driven into soil below said fence, and wherein said drive connector portion has a rearwardly opening recess at said trailing end and a longitudinally extending orifice located between said trailing and leading ends, said orifice and said recess being shaped to engage with a finger and a slot respectively of said applicator, said finger being shaped to engage with, and extend through, said orifice from one side of said arrowhead to the other, and said slot being spaced from said finger and sized to engage both sides of said arrowhead in the vicinity of said rearwardly opening recess, and wherein said method comprising the steps of:
if necessary, connecting the ends said length of wire of U-shaped or V-shaped configuration to said arrowhead;
inter-engaging said tip of said applicator with said drive connector portion of said arrowhead so that said finger engages with, and extends through, said arrowhead orifice from one side of said arrowhead to the other, and said slot engages both sides of said arrowhead in the vicinity of said rearwardly opening recess;
applying inertial impulses to said applicator head to drive said tip into said soil; and
withdrawing said applicator rod from said soil whilst leaving said arrowhead buried in said soil to thereby position a portion of said wire adjacent said bottom wire.

14. The method as claimed in claim 13 including the further step of passing said length of wire of U-shaped or V-shaped configuration around said bottom wire.

15. The method as claimed in claim 13 including the further step of partially drawing said wire out of said soil to thereby firmly inter-engage said soil and said arrowhead.

16. The method as claimed in claim 15 including the further step of twisting or winding said wire adjacent said bend to engage said wire of U-shaped or V-shaped configuration with said bottom wire.

17. The method as claimed in claim 13 including the further steps of, if necessary, bending said arrowhead to simultaneously form opposite convex and concave surfaces on said arrowhead, and driving said arrowhead into the soil with said concave surface lower than said convex surface.

18. A connector wire for use with the anchor as claimed in claim 1, said connector wire comprising a substantially U-shaped or V-shaped bend, and a pair of ends substantially equidistant from said bend and being shaped to engage with said arrowhead.

19. The connector wire as claimed in claim 18 wherein each said end is substantially kinked.

20. The connector wire as claimed in claim 18 wherein said bend and the wire adjacent said bend are coated with a plastics material.

21. The connector wire as claimed in claim 18 wherein said wire is selected from the group consisting of high tensile steel fencing wire, low tensile steel fencing wire, stainless steel wire, plastic coated wire, galvanised wire, tie wire and braided cable.
